(19) United States
(12) Patent Application Publication
(10) Pub. No.: US 2018/0230812 A1
(43) Pub. Date: Aug. 16, 2018

(54) FILM HOLE ARRANGEMENT FOR A TURBINE ENGINE

(71) Applicant: General Electric Company, Schenectady, NY (US)

(72) Inventors: Junwoo Lim, Lynn, MA (US); Jeffrey Douglas Rambo, Mason, OH (US); Aaron Ezekiel Smith, Montgomery, OH (US)

(21) Appl. No.: 15/405,648

(22) Filed: Jan. 13, 2017

(51) Int. Cl. F01D 5/18

(52) U.S. Cl. CPC F01D 5/186; F05D 2220/323; F05D 2240/303; F05D 2260/202; F05D 2250/324; F05D 2250/38; F05D 2250/10

(57) ABSTRACT

An apparatus and method for an engine component for a turbine engine including an exterior wall separating a hot fluid flow exterior of the engine component from a cooling fluid flow interior of the engine component. A cooling circuit can be provided within the component having a cooling passage. At least two film holes can extend through the exterior wall for providing a cooling film along the exterior of the wall. The film holes can overlap one another relative to the hot fluid flow.

### BACKGROUND OF THE INVENTION

Turbine engines, and particularly gas or combustion turbine engines, are rotary engines that extract energy from a flow of combusted gases passing through the engine onto a multitude of rotating turbine blades.

Gas turbine engines for aircraft are designed to operate at high temperatures to maximize engine efficiency, so cooling of certain engine components, such as the high pressure turbine and the low pressure turbine, can be beneficial. Typically, cooling is accomplished by ducting cooler air from the high and/or low pressure compressors to the engine components that require cooling. Temperatures in the high pressure turbine are around 1000° C. to 2000° C. and the cooling air from the compressor is around 500° C. to 700° C. While the compressor air is a high temperature, it is cooler relative to the turbine air, and can be used to cool the turbine.

Contemporary turbine blades generally include one or more interior cooling circuits for routing the cooling air through the blade to cool different portions of the blade, and can include dedicated cooling circuits for cooling different portions of the blade, such as the leading edge, trailing edge and tip of the blade. The cooling circuits can exhaust from the blade through one or more film holes.

### BRIEF DESCRIPTION OF THE INVENTION

In one aspect, the present disclosure relates to an airfoil for a turbine engine including a perimeter wall bounding an interior and defining a pressure side and a suction side extending between a leading edge and a trailing edge to define a chord-wise direction and extending between a root and a tip to define a span-wise direction. A cooling circuit is located within the airfoil and has a cooling passage extending at least partially through the interior. At least one row of film holes defines a row axis and fluidly couples to the cooling circuit, with at least some of the film holes having outlets on the exterior and the outlets overlapping one another orthogonal to the row axis.

In another aspect, the present disclosure relates to a component for a turbine engine, which generates a hot fluid flow and provides a cooling fluid flow. A wall separates the hot fluid flow from the cooling fluid flow and has a hot surface facing the hot fluid flow and a cooling surface facing the cooling fluid flow. At least one row of film holes is disposed in the wall, with the film holes having an inlet and an outlet and fluidly coupled to the cooling fluid flow, with the outlets of the film holes defining an outlet axis along the longest cross-sectional extent of the outlets. The row of film holes are arranged with the outlets overlapping a portion of the adjacent outlet in the direction orthogonal to the outlet axis.

In yet another aspect, the present disclosure relates to a method of cooling a hot surface of a component for a gas turbine engine comprising emitting a cooling air flow along the hot surface through a row a film holes defining a row axis such that the cooling air from one film hole flows over at least a portion of an adjacent film hole.

### BRIEF DESCRIPTION OF THE DRAWINGS

In the drawings:

FIG. 1 is a schematic cross-sectional diagram of a gas turbine engine for an aircraft.

FIG. 2 is a perspective view of an engine component of the engine of FIG. 1 in the form of an airfoil.

FIG. 3 is a cross-sectional view of the airfoil of FIG. 2 taken across section 3-3, illustrating three cooling passages defining at least a portion of a cooling circuit.

FIG. 4 is a view of the surface of the airfoil of FIG. 3 illustrating the film holes with overlapping outlets.

FIG. 5 is a cross-sectional view of one film hole taken across section 5-5 of FIG. 4, illustrating an interior geometry of the film hole.

FIG. 6A is a temperature contour plot for of a set of film holes that are not overlapping.

FIG. 6B is a temperature contour plot for a portion of the film holes of FIG. 4 that are overlapping.

### DESCRIPTION OF EMBODIMENTS OF THE INVENTION

The described embodiments of the present invention are directed to film holes provided in engine components for exhausting a cooling fluid as a cooling film along a hot surface of the engine component. For purposes of illustration, the present invention will be described with respect to an airfoil for the turbine section for an aircraft gas turbine engine. It will be understood, however, that the invention is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

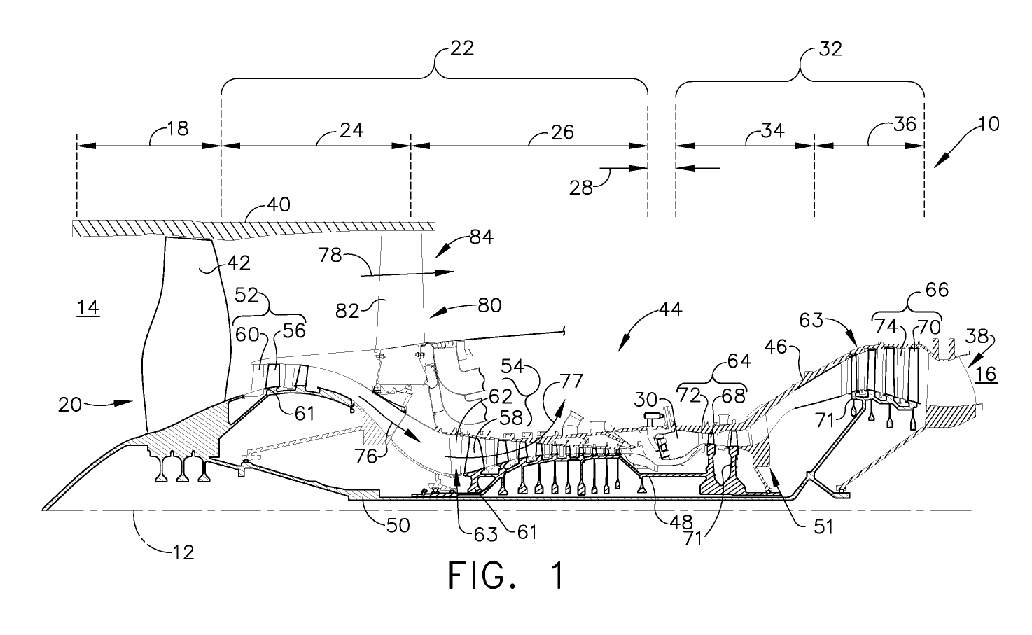

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

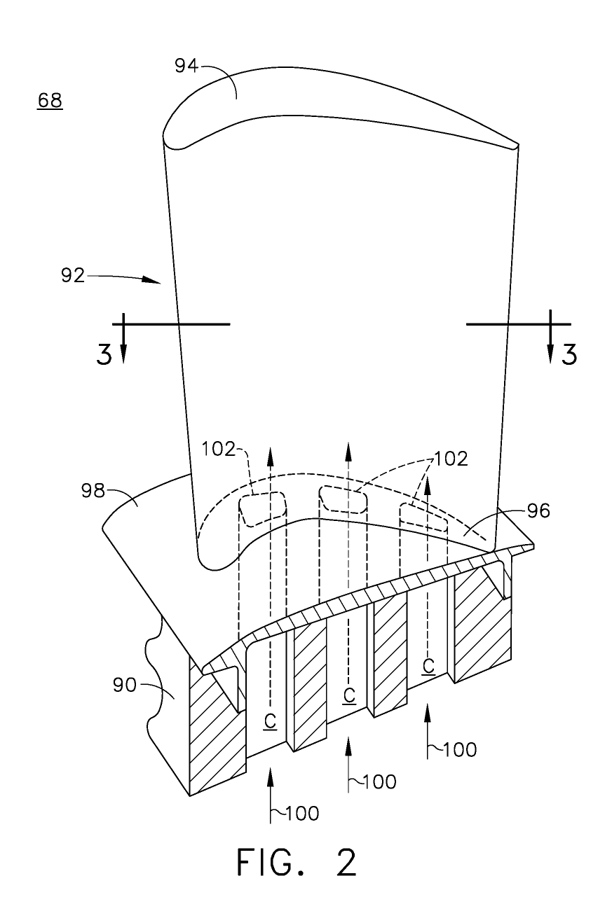

FIG. 2 is a perspective view of an engine component in the form of one of the turbine blades 68 of the engine 10 from FIG. 1. The turbine blade 68 includes a dovetail 90 and an airfoil 92. The airfoil 92 includes a tip 94 and a root 96 defining a span-wise direction therebetween. The airfoil 92 mounts to the dovetail 90 at a platform 98 at the root 96. The platform 98 helps to radially contain the turbine engine mainstream air flow. The dovetail 90 can be configured to mount to a turbine rotor disk 71 on the engine 10. The dovetail 90 further includes at least one inlet passage 100, exemplarily shown as a three inlet passages 100, each extending through the dovetail 90 to provide internal fluid communication with the airfoil 92 at a passage outlet 102. It should be appreciated that the dovetail 90 is shown in cross-section, such that the inlet passages 100 are housed within the body of the dovetail 90.

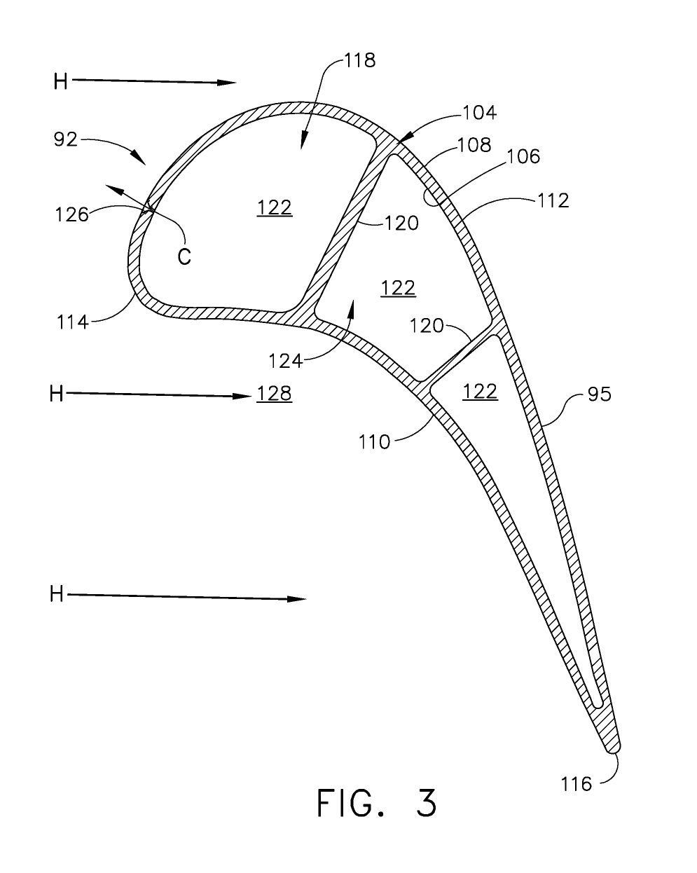

Turning to FIG. 3, the airfoil 92, shown in cross section, includes a wall such as a perimeter wall or outer wall 104 having a cooling surface 106 and a hot surface 108. The cooling surface 106 can be an interior surface of the outer wall 104, while the hot surface 108 can be an exterior surface. The outer wall 104 can further include a pressure sidewall 110 and a suction sidewall 112 which are joined together to define an airfoil shape extending between a leading edge 114 and a trailing edge 116, defining a chord-wise direction therebetween. The airfoil 92 has an interior 118 defined by the outer wall 104. The blade 68 rotates in a direction such that the pressure sidewall 110 follows the suction sidewall 112. Thus, as shown in FIG. 3, the airfoil 92 would rotate upward toward the top of the page.

One or more ribs 120 can divide the interior 118 into multiple cooling passages 122. One or more cooling passage 122 can be interconnected within the interior 118 to form a cooling circuit 124. It should be appreciated that the cooling passages 122 and cooling circuit 124 are exemplary, and can be single channels extending in the span-wise direction, or can be complex cooling circuits, having multiple features such as passages, channels, inlets, pin banks, circuits, sub-circuits, film holes, plenums, mesh, turbulators, or otherwise and such details are not germane to the invention.

A film hole 126 can be provided in the outer wall 104, fluidly coupling the interior 118 to an exterior 128 of the airfoil 92. The film hole 126 can be provided on the suction sidewall 112, of the airfoil 92, adjacent the leading edge 114. Alternatively, the film hole 126 can be provided at any location along the airfoil 92, such as at the leading edge 114, or anywhere along the outer wall 104.

The flow of cooling fluid C of FIG. 2 can be provided to the interior 118 of the airfoil 92 and pass through the cooling circuit 124, while a hot fluid flow H can be provided along the exterior of the airfoil 92, such as combusted gasses from a combustor section 30 of FIG. 1. As such, the interior surface 106 can be a cooling surface and the exterior surface 108 can be a hot surface. In operation, the cooling fluid flow C cools the airfoil 92 under heated operation in the hot fluid flow H. The cooling fluid flow C can exhaust from the interior 118 to the exterior 128 through the film hole 126 in order to provide a cooling film along the exterior surface 108 of the airfoil 92.

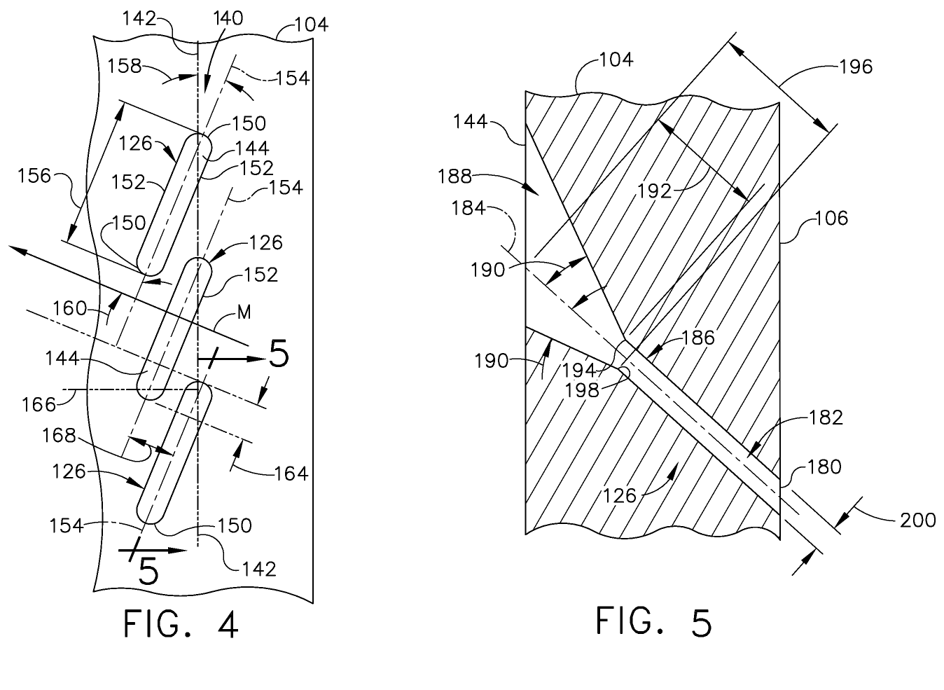

FIG. 4 illustrates a portion of the airfoil 92, showing the outer wall 104 having a row of film holes 126. The film holes 126 can be arranged as two or more film holes 126 in a row 140, shown as three film holes 126. In one non-limiting example, the row 140 can be offset from the leading edge 114 (FIG. 3) or, alternatively, can be located along the leading edge 114. While only one row 140 is shown, there can be any number of rows 140, being aligned, offset, patterned, or organized in any particular manner as may be desirable for the airfoil or the particular engine component.

The row of film holes 140 can define a row axis 142. The row axis 142 can be in the span-wise direction, and can be substantially parallel to a radial axis extending from the engine centerline 12 (FIG. 1), or can be defined in any direction along the surface of the airfoil 92 or engine component. While the row axis 142 is shown as being substantially linear, it should be understood that that row axis 142 can be non-linear, such as following a curvature of a blade curving in the radial direction. The row axis 142 can be measured from anywhere along the row 140 of film holes 126. Additionally, a local streamline for a mainstream airflow M can pass along the outer wall 104. The local mainstream airflow M can be the local flow direction of the flow of air passing through the engine, such as the compressor, combustion, or turbine sections 22, 28, 32, typically driven by the rotating blades 68 (see FIG. 1).

The film holes 126 include outlets 144 having a racetrack shape with two radiused ends 150 connected by two linear sidewalls 152. Each outlet 144 can define a major axis 154. The major axis 154 can be defined along the longest cross-sectional area of the outlets 144, for example. The major axis 154 can be used to define an outlet length 156 from the opposing ends 150 of the outlet 144. While shown as having a racetrack shape, it should be appreciated that the outlet 144 can have any shape, such as symmetric, uniform, non-uniform, variable, or unique. Additional outlet shapes could be geometric, such as a crescent, trapezoidal, or rhomboids in non-limiting examples. Such an outlet 144 can be optimized based upon the local mainstream airflow M, to improve any exhausted cooling fluid spreading over the exterior surface.

Additionally, film hole 126 can be oriented such that the major axis 154 of the outlet 144 is offset from the row axis 142. A first angle 158 can be defined between the major axis 154 and the row axis 142. The first angle 158 can be between 45-degrees and −45-degrees relative to the row axis 142, in one non-limiting example, where a negative angle represents an angle in the opposite direction as the positive angle relative to the row axis 142. Similarly, the first angle 158 can be between 0-degrees and 90-degrees in either direction relative to the row axis 142. Alternatively, a second angle 160 can be defined between the major axis 154 and the local mainstream flow M. The second angle 160 can be 90-degrees, in one non-limiting example, where the direction of expansion of the film hole 126 is orthogonal to the local mainstream flow M. The direction of expansion can be defined along the major axis 154. Alternatively, the second angle 160 can be between 45-degrees and 90-degrees.

Regardless of how the angled orientation of the film hole 126 is determined, being the first or second angles 158, 160 or some other manner, adjacent film holes 126 can overlap one another relative to the local streamline for the hot flow M. As the major axis 154 can be arranged orthogonal to the local streamline flow M, the overlap of adjacent film holes 126 can be defined as an overlap length 164 measured orthogonal to the major axis 154 extending from the adjacent radiused ends 150. Alternatively, the overlap length 164 can be measured parallel to the local flow streamline of the mainstream flow M. The film holes 126 can be intentionally spaced to vary the overlap length 164. In one example, the overlap length 164 can be between 0% and 50% of the length 156 of the outlet 144 taken along major axis 154. In yet another alternate example, the overlap length 164 can be measure along an axis perpendicular to the row axis 142.

It should be appreciated that the outlets 144 can be oriented such that the major axes 154 are offset from orthogonal to the local mainstream flow M. Such an offset can be between 0-degrees and 90-degrees, for example, such that an overlap among adjacent outlets 144 exists. It should be understood that the offset should not be such that the outlets 144 is parallel to or orthogonal to the row axis 142; otherwise no overlap would exist. However, it is contemplated that a uniquely-shaped outlet 144 may enable overlap while having a major axis 154 that is parallel or orthogonal to the row axis 142, and can depend on how the major axis 154 of such a uniquely-shaped outlet 144 is determined.

With respect to the racetrack-shaped outlets 144 shown in FIG. 4, the adjacent film holes 126, or outlets 144 thereof, are spaced from one another by a film hole spacing distance 168, which can be measured orthogonal to the major axes 154 of adjacent film holes 126. The spacing distance 168 can have an impact on the overlap length 164. For example, increasing the distance between the adjacent film holes 126, or outlets 144 thereof in an axial direction or substantially in the direction of the local mainstream flow M, can increase the overlap length 164 of the adjacent film holes 126. However, increasing the spacing between adjacent film holes 126 in a substantially radial or span-wise direction, such as along the row axis 142, can decrease the overlap length 164. As such, the design of the film holes and their spacing should necessitate that an overlap exists with respect to the mainstream flow M. For example, the spacing distance 168 can be 50% or less of the longitudinal length of the outlet 144 taken along the major axis 154. With such an understanding, it should be appreciated that the distance between adjacent film holes 126 in a row of multiple film holes 140 can be varied to maximize overlap while minimizing the total number of film holes 126 or minimizing required outlet size. Therefore, it should be appreciated that spacing of the film holes 126, as well as the overlap length 164 can be balanced with film cooling efficiency, engine efficiency, or component weight in non-limiting examples. Furthermore, the spacing and organization of the film holes 126 can be based upon the mechanical strength of the engine component based upon the web generated between the film holes 126. It should be appreciated that the overlapped design reduces absolute temperature and thermal gradient in the interstitial spaces between the film holes, which can enable a tighter spacing of the film holes 126.

An orthogonal axis 166 can be defined extending from the row axis 142. Alternatively, the outlets 144 can overlap one another relative to the orthogonal axis 166, such that when the orthogonal axis 166 is defined from one end 150 of one film hole 126, it overlaps a portion of the adjacent film hole 126.

It should be appreciated that the film holes 126 can overlap one another by a plurality of ways, as described herein. Such overlap can be defined relative to the mainstream flow M, the orthogonal axis 166, or perpendicular to the major axis 154 defined through the outlet 144. Regardless of how the outlets 144 overlap one another, it should be appreciated that a flow of cooling fluid C exhausting from one outlet 144 can pass over at least a portion of an adjacent film hole outlet 144.

Referring now to FIG. 5, a cross-sectional view taken across section 6-6 of FIG. 4 illustrates the profile of one film hole 126. The film hole 126 includes an inlet 180 on the interior surface 106 opposite of the outlet 144. A passage 182 is defined between the inlet 180 and the outlet 144. The passage 182 can include a linear centerline 184 extending along the longitudinal length of the film hole 126. The film hole 126 can be separated into two portions as an interior portion 186 and an exterior portion 188, where the exterior portion 188 can be diverging as a diverging portion. The interior portion 186 extends into the outer wall 104 from the interior surface 106 at the inlet 180. The interior portion 186 can have a constant cross-sectional area. The interior portion 186 terminates at a terminal edge 194, 198 at the exterior portion 188. The exterior portion 188 can extend within the outer wall 104 from the interior portion 186 to the outlet 144. The exterior portion 188 includes an increasing cross-sectional area extending from the interior portion 186 to the outlet 144 to define a diverging exterior portion 188. The exterior portion 188 can diverge at a diverging angle 190 relative to the centerline 184 of the film hole 126. The diverging angle 190 can be between 0-degrees and 15-degrees, for example. The diverging angle 190 can be variable, such as having a greater or lesser angle at different portions of the exterior portion 188.

The exterior portion 188 can include a length. A first length 192 can be measured as the distance from an upper terminal edge 194 of the interior portion 186 to the outlet 144 parallel to the centerline 184. A second length 196 can be measured as the distance from a lower terminal edge of 198 of the interior portion 186 to the outlet 144 parallel to the centerline 184.

The interior portion 186 of the film hole 126 provides for metering a cooling fluid exhausting into the film hole 126. The diverging exterior portion 188 provides for spreading the cooling fluid across the entirety of the outlet 144, such that a substantially even cooling film is exhausted form the film hole 126. Additionally, the diverging portion 188 provides for the elongated outlet 144 as shown in FIG. 4, such that the film holes 126 can overlap one another by the overlap length 164, without requiring excessively large inlets 180 or hole diameters 200. The diverging portion 188 reduces the required cooling fluid to generate the desired cooling film, as opposed to negatively impacting cooling efficiency with a large, uniform diameter film hole.

It should be appreciated that the cross section shown in FIG. 5 is exemplary of one film hole 126 and is not limiting. It is contemplated two or more film holes in a row 140 can be identical, while it is also contemplated that all film holes 126 can be unique, tailored to the particular position and needs of the engine component or the local mainstream airflow M. As such, angles such as the diverging angle 190, or the angle orientation of the film hole 126 extending through the outer wall 104 can be varied. Additionally, sizes, thicknesses, diameters, and cross-sectional areas of and along the film hole 126 can be adapted for each particular film hole 126.

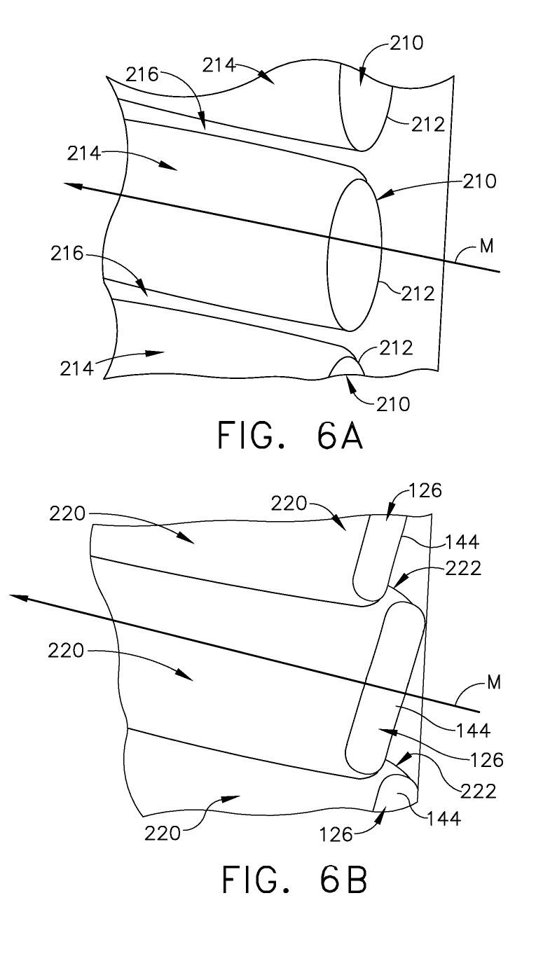

Referring now to FIG. 6A, a temperature gradient plot is illustrated for exemplary film holes 210 with outlets 212 that do not overlap one another, as opposed to the film holes that do overlap one another, which are the subject of this disclosure. Each non-overlapping film hole 210 exhausts cooling fluid to form a wake 214 extending from the outlet 212. Due to the spacing of the film hole outlets 212, gaps 216 form between adjacent wakes 214. The cooling fluid of the wakes 214 does not effectively cool the portions of the engine component in the gaps 216. As such, the engine component can become excessively heated or engine efficiency can suffer. Typically, in order to remedy the gaps, additional rows of film holes are added in an adjacent, offset manner, which can have a negative impact on efficiency. Furthermore, the showerhead organization of the offset film hole rows can still develop gaps in the cooling film, leaving the problem unresolved.

Referring now to FIG. 6B, showing the overlapping film holes 126 of FIG. 4, a cooling fluid can be exhausted from the outlets 144 of the film holes 126 forming a wake 220. The overlapped outlets 144 of the film holes 126 form an overlapping flow 222. The overlapped film holes 126 generating the overlapping flow 222 eliminate the gaps 216 as shown in FIG. 6A and provide for a cooling film covering the entirety of the engine component along the row of film holes 126 downstream of the film hole 126. Covering the entirety of the engine component along the film holes 126 improves film cooling and film effectiveness, which can improve engine durability, time-on-wing, increase operational temperatures for the engine at the component, improve cooling efficiency, and improve engine efficiency.

As such, it should be appreciated that the overlapping film holes 126 can attenuate hot streaks between adjacent film holes 126. Eliminating the gaps between the adjacent film holes 126 prevents hot streaks in an exhausted cooling film bet and provides a cooling film over the entirety of the surface of the engine component at the film holes 126. It should be appreciated that the overlapping film holes 126 eliminates the gaps and hot streaks better than offset rows of non-overlapping film holes or trench cooling with discrete holes in the trenches. The spread cooling film improves component cooling efficiency by minimizing temperature variation along the exterior of the component, which can increase component lifetime, heighten operation temperatures to improve engine efficiency, and reduce required maintenance.

Furthermore, it should be understood that increasing the spacing between adjacent film holes 126, while maintaining a consistent overlap, such as the overlap length 164 of FIG. 4, can allow gaps to form in cooling fluid between the adjacent film holes 126. As such, the spacing, which can be the spacing distance 168 of FIG. 4, between the adjacent film holes 126 should not be great enough to permit the formation of gaps in the exhausted cooling film.

It should be further appreciated that the overlapping film holes 126 cover a the entire surface area downstream of the film holes as opposed to non-overlapping film holes, showerhead organizations of non-overlapping film holes, or film holes provided in troughs extending along the surface of the engine component, as well as other typical film holes organizations.

A method of providing a cooling film along a hot surface of a component for a turbine engine in a hot fluid flow can include: (1) supplying cooling air to an interior of the component, and (2) exhausting at least a portion of the supplied cooling air as a cooling film through two or more film holes defining a stacking axis. The film holes of the method are arranged overlapping one another in a direction orthogonal to the stacking axis. Supplying the cooling air to an interior of a component can include ducting air, such as bypass air, from other portions of the engine to the engine component, such as providing cooling air to the interior of the airfoil through the inlet passages 100 as shown in FIG. 2. In a preferred example, ducted bypass air can be provided to the engine component from the compressor section of the engine having a substantially lower temperature as opposed to heated air in the turbine section.

Exhausting at least a portion of the supplied cooling air as a cooling film through two or more film holes defining a stacking axis can include exhausting a portion of the cooling fluid provided to the interior of the airfoil through the film holes, such as the film holes 126 of FIG. 4. The two or more film holes 126 can be arranged in a row defining the row axis 142 such as that of FIG. 4, which can be in a substantially radial direction for the airfoil, for example. The film holes 126 overlap one another, as described herein, in a direction orthogonal to the stacking axis. Alternatively, the film holes can overlap one another in a direction parallel to a local streamline flow passing the film holes, such as that described in FIG. 4.

It should be appreciated that the arrangement of overlapping film holes as described herein provide for diffusing a cooling film along an exterior surface of an engine component in a substantially uniform manner covering the entire surface of the engine component downstream of the film holes, minimizing or eliminating discrete locations where the cooling film does not pass over the surface of the component. The organization of the film holes minimizes patterns of hot streaks, which reduces temperature variation along the exterior surface of engine components and improves cooling efficiency and effectiveness. The improved cooling can provide for extended component lifetime, increased operational temperatures, improved cooling efficiency, and improved engine efficiency.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil for a turbine engine, the airfoil comprising:
a perimeter wall bounding an interior and defining an exterior with a pressure side and a suction side extending between a leading edge and a trailing edge to define a chord-wise direction and extending between a root and a tip to define a span-wise direction;
a cooling circuit located within the airfoil and having a cooling passage extending at least partially through the interior; and
at least one row of film holes defining a row axis and fluidly coupled to the cooling circuit, with at least some of the film holes having outlets on the exterior and the outlets overlapping one another orthogonal to the row axis.

2. The airfoil of claim 1 wherein the outlet is non-circular.

3. The airfoil of claim 2 wherein the outlet is elongated having opposing ends.

4. The airfoil of claim 3 wherein the outlet increases in depth along a portion of the film holes through the perimeter wall in a directed between the opposing ends.

5. The airfoil of claim 1 wherein the at least row includes a plurality of rows.

6. The airfoil of claim 1 wherein the at least one row is located along the leading edge.

7. The airfoil of claim 1 wherein the outlets are elongated and define a major axis, wherein the film holes are oriented at an angle relative to the row axis.

8. The airfoil of claim 7 wherein the angle is between 0 and 45 degrees relative to the row axis.

9. The airfoil of claim 7 wherein a projection of the angle onto a plane common with the row axis is between 0 and 90 degrees relative to the row axis.

10. The airfoil of claim 7 wherein the major axis is perpendicular to the local stream line for a main stream flow.

11. The airfoil of claim 1 wherein the outlet overlaps an adjacent outlet by an overlap length that is between 0% and 50% a length of the outlet taken as the greatest cross-sectional distance of the outlet.

12. The airfoil of claim 1 wherein the at least some film holes further comprise an inlet on the interior and a passage connecting the inlet to the outlet, wherein the film holes are shaped such that the inlet and the outlet are different shapes or sizes.

13. The airfoil of claim 12 wherein at least a portion of the passage is diverging.

14. The airfoil of claim 13 wherein the diverging portion of the passage diverges at a diverging angle between 0 and 15 degrees relative to a centerline of the passage.

15. The airfoil of claim 14 wherein the diverging portion of the passage defines a length parallel to the centerline of the passage and wherein the inlet further includes a diameter and wherein the passage defines a ratio of length to diameter that is less than 5.

16. A component for a turbine engine that generates a hot fluid flow and provides a cooling fluid flow, the component comprising:
a wall separating the hot fluid flow from the cooling fluid flow and having a hot surface facing the hot fluid flow and a cooling surface facing the cooling fluid flow; and
at least one row of film holes disposed in the wall, with the film holes having an inlet and an outlet and fluidly coupled to the cooling fluid flow, with the outlets of the film holes defining outlet major axis along the longest cross-sectional extent of the outlets;
wherein the row of film holes are arranged with the outlets overlapping a portion of the adjacent outlet in the direction orthogonal to the major axis.

17. The component of claim 16 wherein the at least one row of film holes include a plurality of film holes.

18. The component of claim 16 wherein the at least one row of film holes defines a row axis and the major axis is oriented at an angle relative to the row axis.

19. The component of claim 18 wherein the angle is between 0 and 45 degrees.

20. The component of claim 16 wherein the inlet and the outlet define a passage extending therebetween, wherein the film holes are shaped such that the inlet and the outlet are different shapes or sizes.

21. The component of claim 20 wherein at least a portion of the passage is diverging.

22. The component of claim 21 wherein the diverging portion of the passage defines a length parallel to a centerline of the passage and wherein the inlet further includes a diameter and wherein the passage defines a ratio of length to diameter that is less than 5.

23. The component of claim 16 wherein the outlet overlaps the adjacent outlet by between 0% and 50% a length of the outlet taken along the major axis.

24. A method of cooling a hot surface of a component for a gas turbine engine comprising emitting a cooling air flow along the hot surface through a row of film holes defining a row axis such that the cooling air from one film hole flows over at least a portion of an adjacent film hole.

25. The method of claim 24 further comprising flowing a hot air flow over the hot surface and the cooling air is emitted perpendicular to a local stream line flow.

26. The method of claim 24 further comprising diffusing the cooling air from the film holes.

27. A component for a turbine engine that generates a hot fluid flow defining a local mainstream flow along the component, and provides a cooling fluid flow, the airfoil comprising:
a perimeter wall separating the hot fluid flow from the cooling fluid flow and having a hot surface facing the hot fluid flow and a cooling surface facing the cooling fluid flow; and
a row of film holes disposed in the outer wall, with the film holes having an inlet and an outlet and fluidly coupled to the cooling fluid flow, with the outlets of the film holes defining outlet major axis along the longest cross-sectional extent of the outlets;
wherein the row of film holes are arranged with the outlets overlapping a portion of an adjacent outlet in the direction relative to the local mainstream flow of the hot fluid flow.

28. The component of claim 27 wherein the film holes are positioned such that the major axis is orthogonal to the local mainstream flow of the hot fluid flow.

29. The component of claim 27 wherein the row of film holes defined a row axis and major axis of the outlets is oriented at an angle relative to the row axis between 0 and 45 degrees.
